(19) United States
(12) Patent Application Publication
(10) Pub. No.: US 2025/0292215 A1
(43) Pub. Date: Sep. 18, 2025

(54) SYSTEMS AND METHODS FOR IDENTIFYING EQUIPMENT AND OPERATIONAL ENVIRONMENTS AND FOR PRESENTING REPAIR AND REPLACEMENT INFORMATION

(71) Applicant: Lenovo Global Technology (United State) Inc., Morrisville, NC (US)

(72) Inventors: Nathan Peterson, Morrisville, NC (US); Shane Smith, Morrisville, NC (US); Chris Tuttle, Morrisville, NC (US)

(21) Appl. No.: 18/608,850

(22) Filed: Mar. 18, 2024

(51) Int. Cl. G06Q 10/20

(52) U.S. Cl. CPC G06Q 10/20; G06F 16/434; G06F 16/53; G06F 16/538; G06V 10/40

(57) ABSTRACT

Systems and methods for identifying equipment and operational environments and for presenting repair and replacement information are disclosed. According to an aspect, a system includes an image capture device configured to capture one or more images of equipment within an operational environment. The system also includes an equipment analyzer configured to identify equipment and/or the operational environment within the captured image(s). The equipment analyzer is also configured to search the database(s) for repair and replacement information based on the identified equipment and/or the operational environment. The equipment analyzer is also configured to present the repair and replacement information via a user interface.

### TECHNICAL FIELD

The presently disclosed subject matter relates generally to equipment repair and replacement. Particularly, the presently disclosed subject matter relates to identification of equipment and operational environments and to presentation of repair and replacement information about the same.

### BACKGROUND

Electrical and mechanical equipment often needs repair or replacement. Equipment repair and replacement can require that the technician have knowledge about the equipment's specifications, parts, model, associated costs, warranty information, and the like. Apart from knowledge about the equipment, it may be beneficial for the technician to know about suitable replacement equipment and parts. Other beneficial information may be the environment or specific application for which the equipment is being used. Such information can shorten the time needed for replacement or repair, reduce costs, and help the technician with selecting among alternative solutions for repairing or replacing the equipment.

Current solutions for finding information about equipment include searching the internet, finding the equipment's user manual, or consulting with another expert in the field. It would be beneficial to provide systems and techniques for more efficiently providing needed equipment repair and replacement-related information to a technician.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a system for identifying equipment and operational environments and for presenting repair and replacement information in accordance with embodiments of the present disclosure;

FIG. 2 is a flow diagram of an example method of identifying equipment and operational environments and for presenting repair and replacement information in accordance with embodiments of the present disclosure;

FIG. 3 is a computing device being directed by a user towards a refrigerator that the user intended to repair or replace;

FIG. 4 is a bottom view of a computing device for image capture to search for replacement or repair in accordance with embodiments of the present disclosure; and

FIG. 5 is a flow diagram of another example method of identifying equipment and operational environments and for presenting repair and replacement information in accordance with embodiments of the present disclosure.

### SUMMARY

The presently disclosed subject matter relates to systems and methods for identifying equipment and operational environments and for presenting repair and replacement information. According to an aspect, a system includes an image capture device configured to capture one or more images of equipment within an operational environment. The system also includes an equipment analyzer configured to identify equipment and/or the operational environment within the captured image(s). The equipment analyzer is also configured to search the database(s) for repair and replacement information based on the identified equipment and/or the operational environment. The equipment analyzer is also configured to present the repair and replacement information via a user interface.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, REFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini-or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

As referred to herein, a “user interface” is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

Computing devices described herein may be configured to implement a technology referred to as “computer vision”. Computer vision functionalities can enable a computing device to process and analyze visual or image data to extract meaningful information, make decisions, and perform tasks, operations, or processes. Example functions of computer vision includes, but are not limited to, image capture or acquisition, image processing, feature extraction, image understanding, deep learning and machine learning, and three-dimensional (3D) vision. A suitable camera may be used by the computing device to capture one or more images and/or video to which subsequent computer vision functionalities can be applied. The computing device may subsequently apply image preprocessing to the captured image data for reducing noise, enhancing images, resizing, color correcting, etc. to improved image quality for analysis. Subsequently, computer vision functionality may extract relevant features from images such as, but not limited to, edges, corners, textures, colors, shapes, and/or the like. These features can represent objects or patterns in captured images. The computer vision functionality may also implement high level processing for interpreting the content of the captured images.

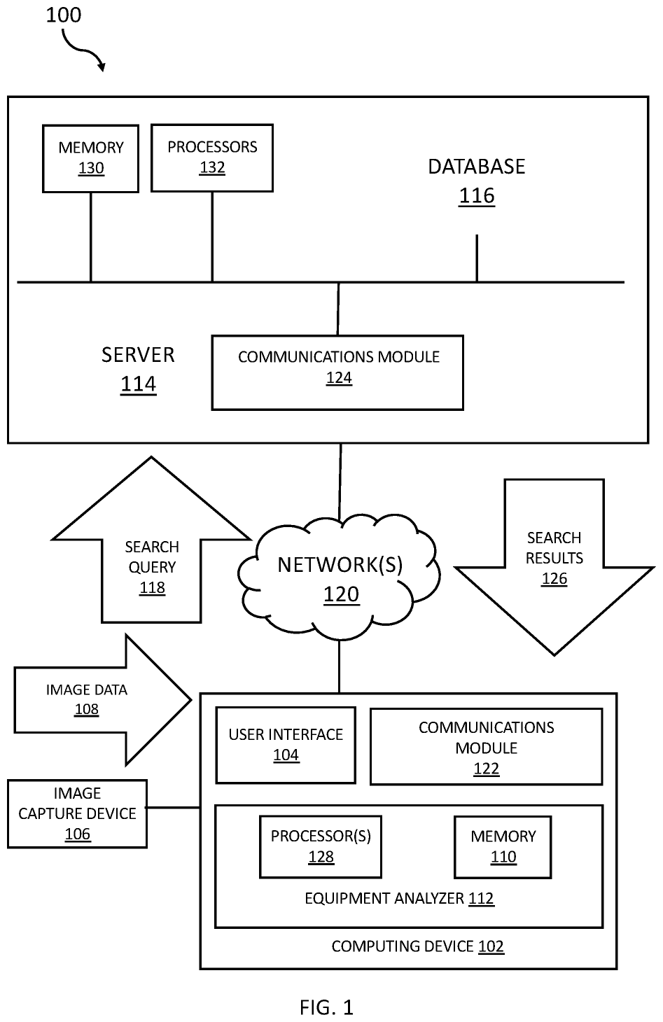

FIG. 1 illustrates a block diagram of a system 100 for identifying equipment and operational environments and for presenting repair and replacement information in accordance with embodiments of the present disclosure. Referring to FIG. 1, the system 100 includes a computing device 102 operable by a user. The user may interact with the computing device 102 via a user interface 104 (e.g., touchscreen display). For example, the computing device 102 may be a smartphone, and the user may interact with a touchscreen display of the user interface 104 to open an application (also referred to as an “app”) for capturing one or more images and/or video. The image(s) and/or video may be captured by an image capture device 106 residing on or apart from the computing device 102. Image data 108 of the captured image(s) and/or video may be communicated to the computing device 102 for storage. For example, the image data 108 of the image(s) and/or video may be stored in memory 110 of the computing device 102. The image(s) and/or video may be captured of an object, such as equipment within an operational equipment.

The computing device 102 includes an equipment analyzer 112 configured to identify objects or other features in captured image(s) and/or video. For example, the equipment analyzer 112 alone or in combination with another computing device may identify an object and/or other features using computer vision functionalities. In an example, the equipment analyzer 112 can identify equipment and/or an operational environment of the equipment within the captured image(s) and/or video. In another example, an augmented reality (AR) technique alone or in combination with a computer vision technique may be used for identifying equipment and/or its operational environment.

For example, an object in a captured image may be an electronic device, such as a computer. In other non-limiting examples, the object may be a household appliance, a part of an electronic device, a part of a household appliance, or the like. The equipment analyzer 112 can utilize computer vision functionalities for identifying the object based on one or more of its features. In another example, the object (e.g., equipment) may be identified based on a machine-readable code (e.g., a QR code, bar code, or the like), name (e.g., name and/or model badging on a product), or other identifier on the object. In this example, the equipment analyzer 112 can interpret the machine-readable code, name, or other identifier in the image for identifying the object (or equipment). The equipment analyzer 112 can store one or more identifiers for the object in memory 110.

Subsequent to acquiring images and identifying equipment within the image, the user of the computing device 102 can be presented with identification of the equipment. In this way, the user may interact with the user interface 104 to confirm that the intended equipment has been identified. Identification of the equipment to the user via the user interface 104 may be by any suitable technique such as, but not limited to, presentation (e.g., display) of a name, model, image, serial number, model number, or the like. As a result, it may be verified by the user that the intended equipment captured in the image(s) and/or video has been correctly identified by the equipment analyzer 112.

The equipment analyzer 112 can search one or more databases for repair and replacement information based on an identified object or feature in an image, such as identified equipment and/or its operational environment. For example, the equipment analyzer 112 can determine a type, specifications, size, and/or the like about the identified equipment. The equipment analyzer 112 can determine this information about the identified equipment by accessing one or more databases for information about the identified equipment. For example, a remote server (or other type of computing device) 114 can store information about various equipment, including the identified equipment, within its database 116. This information about the identified equipment (and other equipment) can include, but is not limited to, the identifier's type, specifications, size, and/or the like. The information can be searched based on an identifier. The equipment analyzer 112 can search information about the identified equipment by communicating a search query 118 containing a suitable identifier of the equipment to the server 114. The search query 118 may be communicated to the server 114 via one or more networks 120. The network(s) 120 may include, but are not limited to, the internet, a cellular network, and a local area network. The equipment analyzer 112 can control a communications module 122 of the computing device 102 to send the search query 118. The server 114 may include a communications module 124 operable to receive the search query 118 via the network(s) 120.

Subsequent to receiving the search query 118, the server 114 can look up or search for stored information about the identified equipment in database 116 based on the identifier. The stored information may include, but is not limited to, repair and/or replacement information for the identified equipment. The server 114 can subsequently send a communication of search results 126 for the identified equipment to the computing device 102. The search results 126 can include the repair and/or replacement for the identified equipment. Subsequent to receipt of the search results 126, the equipment analyzer 112 can present the repair and/or replacement information via the user interface 104. As a result, the user can have available this information for repairing or replacing the identified equipment.

The equipment analyzer 112 can be implemented by suitable hardware, software, firmware, or combinations thereof for implementing the functionalities described herein. For example, the computing device 102 can include memory 110 and one or more processors 128.

The server 114 can include suitable hardware, software, firmware, or combinations thereof for implementing the functionalities described herein. For example, the server 114 can include memory 130 and one or more processors 132. It is also noted that in the example of FIG. 1, only database 116 is described as being utilized for searching for repair and replacement information based on an identifier for equipment; however, it should be understood that a search query may be sent to multiple computing devices having a database and/or access to a database that may contain relevant information about the equipment. For example, multiple search requests may be sent to multiple different computing devices for searching their databases for the information. These computing devices may return their search results. The equipment analyzer 112 may compile and present the received search results to the user.

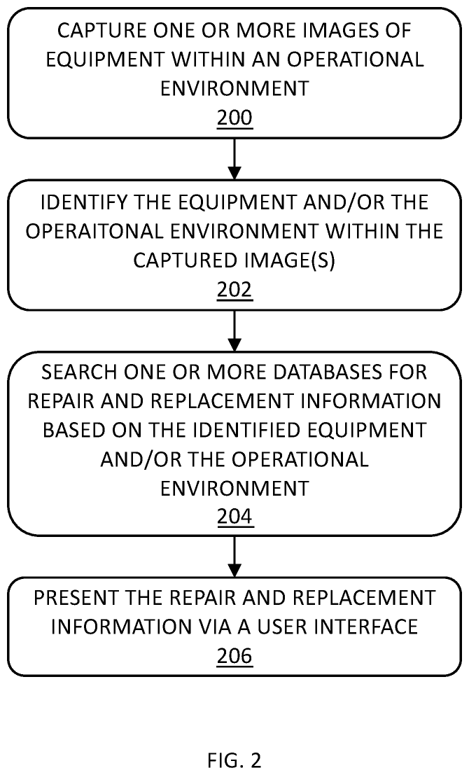

FIG. 2 illustrates a flow diagram of an example method of identifying equipment and operational environments and for presenting repair and replacement information in accordance with embodiments of the present disclosure. It is noted that the method is described as being implemented by the system 100 shown in FIG. 1, but it should be recognized that the method may alternatively be implemented by another suitable computing system.

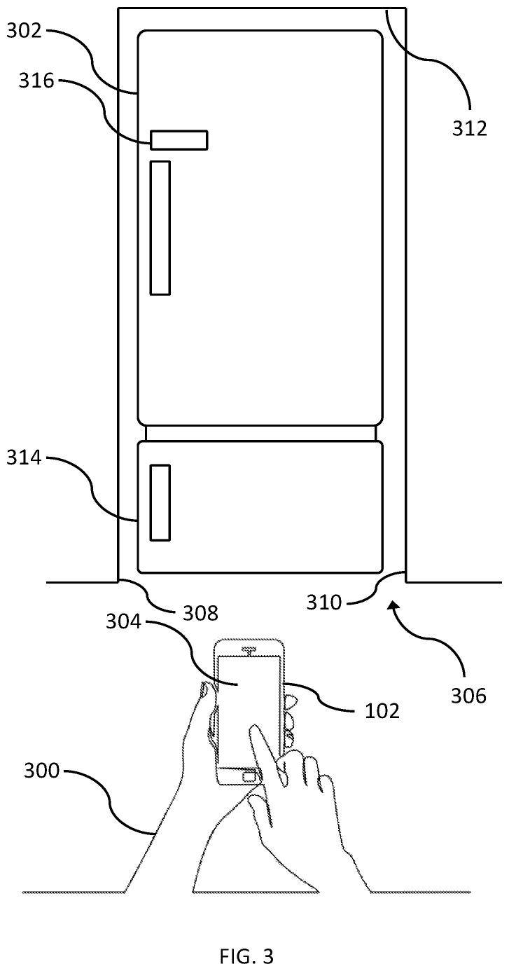

Referring to FIG. 2, the method includes capturing 200 one or more images of equipment within an operational environment. For example, a user can point the computing device 102 shown in FIG. 1 such that its camera is directed towards equipment intended for repair or replacement. FIG. 3 illustrates a computing device 102 being directed by a user (only the user's hands and forearms are shown for ease of illustration) 300 towards a refrigerator 302 that the user 300 intended to repair or replace. Referring to FIG. 3, the user 300 is shown holding the computing device 102 with a right hand, and interacting with a touchscreen display 304 with a left hand. The user 300 can interact with the display by touch to control the computing device's 102 camera to capture an image of the refrigerator 302. The captured image may also include an operational environment of the refrigerator 302. In this example, the refrigerator 302 is positioned within a recessed area, generally designated 306, defined by a left side 308, a right side 310, and a top side 312 of cabinetry. The refrigerator 302 narrowly fits into the recessed area 306, and therefore the size of a replacement refrigerator is a main consideration of the user 300 when replacing it. Turning again to FIG. 1, the equipment analyzer 112 can store in memory 110 the captured image of the refrigerator 300 and its operational environment of the recessed area 306.

The method of FIG. 2 includes identifying 202 the equipment and/or the operational environment within the captured image(s). Continuing the aforementioned example, the equipment analyzer 112 may utilize computer vision for identifying the refrigerator 302. For example, the computer vision functionalities may recognize edges, a shape, dimensions, and other features of the refrigerator 302 to recognize it as being a refrigerator. The equipment analyzer 112 may utilize computer vision for recognizing a specific type of refrigerator. In this example, the equipment analyzer 112 may recognize that refrigerator 302 has a freezer compartment 314 on its bottom. Therefore, in this example, the equipment analyzer 112 may identify the equipment in the captured image as being a refrigerator with bottom freezer.

The equipment analyzer 112 may also recognize the operational environment of the refrigerator 302. Particularly, for example, computer vision functionalities used by the equipment analyzer 112 may detect the edges of sides 308, 310, and 312 in the captured images. Based on the detections of the edges, the equipment analyzer 112 may determine that the operational environment of the refrigerator 302 is within the edges of sides 308, 310, and 312. Further, the equipment analyzer 112 may deduce a requirement of the operational environment of the refrigerator 302 is that any replacement must fit within the sides 308, 310, and 312. Further, the equipment analyzer 112 may utilize suitable dimension/distance functionalities to determine the distance and dimensions between sides 308 and 310, and also a height to top side 312 for determining dimension and size requirements for a replacement refrigerator. The equipment analyzer 112 can store this dimension and size requirements in memory 110.

In another example, the refrigerator 302 may include a name and/or logo in an area generally designated 316. The equipment analyzer 112 can recognize the name and/or logo in the captured image to determine a brand or model of the refrigerator 302. This information may be utilized for searching for a replacement and/or part for refrigerator 302.

The method of FIG. 2 includes searching 204 one or more databases for repair and replacement information based on the identified equipment and/or the operational environment. Continuing the aforementioned example, the equipment analyzer 112 can generate a search query including the information gathered or determined based on the captured image of the refrigerator 302 and its operational environment within the recessed area 306. For example, the search query for the captured image of FIG. 3 can include, but is not limited to, refrigerator type of bottom freezer, dimensions and sizes of operational environment, brand of refrigerator, and model of refrigerator. The generated search query can then be communicated to one or more computing devices (e.g., server 114) for search of database(s) based on this information. The computing device can use one or more parts of the information in the search query to search for a replacement and/or part for refrigerator 302. The replacement refrigerator or part may be the same or similar to the refrigerator 302. The server 114 may subsequently send the results of the query to the computing device via network(s) 120.

The method of FIG. 2 includes presenting 206 the repair and replacement information via a user interface. Continuing the aforementioned example, the computing device 102 can receive the search results at its communication module 122. The equipment analyzer 112 can subsequently control the user interface 104 to present information about the replacement and/or part for the refrigerator 302. For example, the touchscreen display 304 can display the replacement and/or part information for use by the user 300 in selecting a replacement part or refrigerator. The replacement may be similar to the refrigerator or the same, and fit within the recessed area 306.

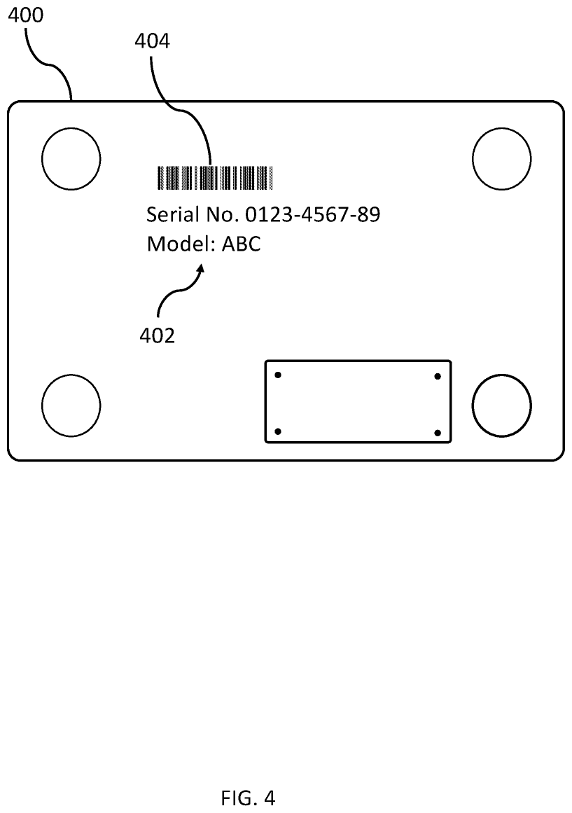

FIG. 4 illustrates a bottom view of a computing device 400 for image capture to search for replacement or repair in accordance with embodiments of the present disclosure. Referring to FIG. 4, the computing device 400 has a serial number and model information, generally indicated by reference number 402, on its bottom side. Also, a barcode 404 is on the bottom side. An image may be captured of the bottom side of the computing device 400. In accordance with embodiments, the barcode information, serial number, and/or model information may be utilized for determining a replacement for the computing device 400 and/or parts for the computing device 400. This information may be displayed on a computing device, such as computing device 102, so that the user can obtain a replacement or parts for the computing device 400.

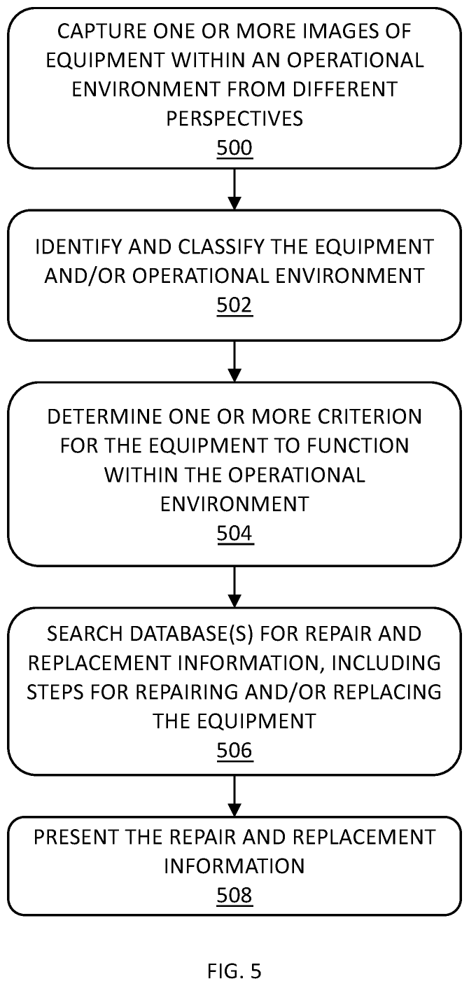

FIG. 5 illustrates a flow diagram of another example method of identifying equipment and operational environments and for presenting repair and replacement information in accordance with embodiments of the present disclosure. It is noted that the method is described as being implemented by the system 100 shown in FIG. 1, but it should be recognized that the method may alternatively be implemented by another suitable computing system. In addition, this example method is described as capturing images of the refrigerator 300 shown in FIG. 3, but it should be understood that the method may be similarly applied to any other equipment in a different operational environment.

Referring to FIG. 5, the method includes capturing 500 one or more images of equipment within an operational environment from different perspectives. For example referring to FIG. 3, an image of the refrigerator 300 may be captured when the computing device 102 is in the position shown in the figure. Also, images of the refrigerator 300 from other perspectives may be captured by moving the computing device 102 up, down, right, or left and pointing the computing device 102 towards the refrigerator 300 to capture images. By capturing images from these different views, more information is available of the refrigerator 300 and its operational environment for search of databases for repair and replacement information.

The method of FIG. 5 includes identifying and classifying 502 the equipment and/or operational environment. Continuing the aforementioned example, the equipment analyzer 112 can determine that an object is classified as a home appliance. Such classification can be used to select which databases to search. In the example of searching for home appliance related information, the equipment analyzer 112 can determine to send the search request to only databases related to home improvement sales.

The method of FIG. 5 includes determining 504 one or more criterion for the equipment to function within the operational environment. Continuing the aforementioned example, the equipment analyzer 112 can determine criteria for a replacement for the refrigerator 300 of FIG. 3 within its operational environment to function. For example, the equipment analyzer 112 may analyze the recessed area 306 to determine its dimensions and the maximum size of a replacement refrigerator to fit in the space. For example, the equipment analyzer 112 may determine that the distance from the floor to the top side 312 is a particular distance and that at least 2 inches of clearance is needed for the replacement refrigerator. Similarly, the equipment analyzer 112 may determine a distance between sides 308 and 310, and determine that at least 4 inches of width clearance is needed for the replacement refrigerator. Thus, the height and width clearance distances are maximum sizes for a replacement refrigerator.

In another example of the computing device 400 shown in FIG. 4, the equipment analyzer 112 may determine a memory, processing speed, or other specifications of the computing device 400. This information may be determined based on the information of barcode 404 and/or the serial number and model information 202. Based on this information, the equipment analyzer 112 may determine its memory, processing speed, or other specifications and deduce that a replacement computing device should have at least these minimum specifications.

The method of FIG. 5 includes searching 506 one or more databases for repair and replacement information, including steps for repairing and/or replacing the equipment. Continuing the aforementioned example, the equipment analyzer 112 can generate a search query that specifies criterion for replacement and/or repair of the equipment. In the example of the refrigerator 300 of FIG. 4, the search query may indicate the determined maximum sizes for a replacement refrigerator. In the example of the computing device 400, the search query may indicate determined minimum requirements of memory, processing speed, and/or other specifications. The search query may subsequently be sent for search of databases, such as database 116 shown in FIG. 1.

The method of FIG. 5 includes presenting 508 the repair and replacement information. Continuing the aforementioned example, the server 114 may search its database 116 based on the search criteria (e.g., maximum sizes of a refrigerator or minimum specifications for a computing device). Results of the search may be returned to the computing device 102. Subsequently, the equipment analyzer 112 can control the user interface 104 to display the search results. The search results may include multiple different repair and replacement options, such as multiple different brands of refrigerators meeting the criteria.

In accordance with embodiments, a user may enter information for identifying the equipment and/or specification requirements for replacement and/or repair. For example in the case of a refrigerator, the user may interact with the user interface 104 to specify that a replacement refrigerator must have an ice maker. Thus, in addition to requirements such as a maximum size of the refrigerator, a search may also include the requirement that the replacement refrigerator has an ice maker.

In accordance with embodiment, search results may include information about steps for the repair and replacement of the equipment. In the case of a refrigerator, the search results may indicate where the old refrigerator can be disposed of or sold. In addition in this example, the search results may include information about safety for installing the replacement refrigerator and a reminder about connecting to water in the case of an ice maker. The user may enter, via the user interface 104, a request for the repair and replacement information for the identified equipment in order to initiate the search request.

In an example scenario, a user may capture an image of an automobile. Further, the user may interact with a smartphone's display to ask for options to order a replacement oil filter. The equipment analyzer can identify the automobile and search for a replacement oil filter and also recommend a type of oil for replacing the automobile's oil.

In another example scenario of a dishwasher, a user may capture an image of the dishwasher and enter the question “What dishwasher could I replace this with?” In this example, the equipment analyzer can determine that it is a dishwasher, and also the brand, model number, or series. Based on this information, the equipment analyzer can determine the specifications of the dishwasher and compare it with currently available dishwasher models to present options for replacement.

In another example scenario, an image of a television can be captured. The user may then enter “I need a replacement remote control”. Subsequently, the equipment analyzer can conduct a search for suitable replacement remote controls for the identified television.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A system comprising:
an image capture device configured to capture one or more images of equipment within an operational environment;
an equipment analyzer comprising at least one processor and memory configured to:
identify equipment and/or the operational environment within the captured one or more images;
search one or more databases for repair and replacement information based on the identified equipment and/or the operational environment; and
present the repair and replacement information via a user interface.

2. The system of claim 1, wherein the equipment analyzer is configured to classify the equipment and/or the operational environment, and
search the one or more databases for repair and replacement information based on the classification of the equipment and/or the operational environment.

3. The system of claim 1, wherein the one or more images comprises a plurality of images captured of the equipment and the operational environment from different perspectives.

4. The system of claim 1, wherein the captured one or more images include machine-readable code that identifies the equipment, and
wherein the equipment analyzer reads the machine-readable code to identify the equipment and/or one or more parts of the equipment.

5. The system of claim 1, wherein the equipment comprises an electronic device, a household appliance, a part of an electronic device, or a part of a household appliance.

6. The system of claim 1, wherein the equipment analyzer is configured to:
determine a class of the equipment;
determine at least one criterion for equipment within the class to function within the operational environment; and
search the one or more databases for repair and replacement information based on the at least one criterion.

7. The system of claim 6, wherein the at least one criterion includes one or more of a size, shape, and/or technical specification.

8. The system of claim 6, wherein the equipment analyzer is configured to present the at least one criterion via the user interface.

9. The system of claim 1, wherein the equipment analyzer is configured to present information about steps for repairing and/or replacing the equipment within the operational environment.

10. The system of claim 1, wherein the equipment analyzer is configured to use the user interface to:
receive user input that identifies the equipment and/or environment; and
receive a user request for the repair and replacement information for the equipment.

11. The system of claim 1, wherein the equipment analyzer is configured to present, via the user interface, a plurality of repair and replacement options.

12. The system of claim 1, wherein the equipment analyzer is configured to utilize a computer vision technique and/or an augmented reality technique for identifying the equipment and/or the operational environment.

13. The system of claim 1, wherein the equipment analyzer is configured to:
communicate one or more identifiers of the equipment and/or operational environment to at least one computing device; and
communicate, to the at least one computing device, a request for the repair and replacement information.

14. A method comprising:
using an image capture device to capture one or more images of equipment within an operational environment;
identify equipment and/or the operational environment within the captured one or more images;
search one or more databases for repair and replacement information based on the identified equipment and/or the operational environment; and
present the repair and replacement information via a user interface.

15. The method of claim 14, further comprising:
classifying the equipment and/or the operational environment; and
searching the one or more databases for repair and replacement information based on the classification of the equipment and/or the operational environment.

16. The method of claim 1, wherein the captured one or more images include machine-readable code that identifies the equipment, and
wherein the method further comprises reading the machine-readable code to identify the equipment and/or one or more parts of the equipment.

17. The method of claim 1, further comprising:
determining a class of the equipment;
determining at least one criterion for equipment within the class to function within the operational environment; and
searching the one or more databases for repair and replacement information based on the at least one criterion.

18. The method of claim 17, wherein the at least one criterion includes one or more of a size, shape, and/or technical specification.

19. The method of claim 17. further comprising presenting the at least one criterion via the user interface.

20. The method of claim 1. further comprising utilizing a computer vision technique and/or an augmented reality technique for identifying the equipment and/or the operational environment.
